(19) United States
(12) Patent Application Publication
(10) Pub. No.: US 2004/0154546 A1
(43) Pub. Date: Aug. 12, 2004

(54) Milking device

(76) Inventors: Daan Van der Lingen, Hasselt (NL); Peter W Van der Sluis, IJsselmuiden (NL)

Correspondence Address: Richard L Byrne, 700 Koppers Building, 436 Seventh Avenue, Pittsburgh, PA, 15219-1818, US

(21) Appl. No.: 10/476,439

(22) PCT Filed: May 2, 2002
(86) PCT No.: PCT/NL02/00288

(30) Foreign Application Priority Data
May 2, 2001 (NL) 1017984

(51) Int. Cl. A01J 3/00

(52) U.S. Cl. 119/14.03

(57) ABSTRACT

Disclosed is an apparatus for milking livestock such as cows. A block-shaped frame is open on one side and has a front side and a rear side relative to respectively head and udder of livestock are provided for milking in the milking box. A movable entrance and/or exit gate is provided for selectively opening an entrance and/or exit in the open side of the frame. Teat cups are provided for milking the livestock with, for instance, a milking robot. Placing means are provided for positioning livestock for milking at a desired location with udders thereof at a predefined location. The placing means comprise a frame part on the rear side of the frame. The frame part is movable away from and toward the front side of the frame. The milking robot is adapted to orient itself to the udders in relation to the frame part.

The present invention relates to an apparatus for milking livestock such as cows, comprising: a block-shaped frame open on one side and having a front side and a rear side relative to respectively head and udder of livestock for milking in the milking box, and having a movable entrance and/or exit gate for selectively opening an entrance and/or exit in the open side of the frame; teat cups for milking the livestock with for instance a milking robot; and placing means for positioning livestock for milking at a desired location with udders thereof at a predefined location.

Such apparatuses for milking livestock are generally known. It is herein possible for a single gate to be used as entrance and as exit or for a separate entrance gate to be arranged additionally to the exit gate.

Such a milking box is for instance known from EP-A-0.432.148, wherein as placing means use is made of a feed trough displaceable in the lengthwise direction of the milking box. The length of the space available for an animal for milking is adjusted by displacing the feed trough, so that the animal for milking is placed with its rear close to a rear wall of the milking box. It is the objective here to reduce the search area in which the milking robot must search for particularly the teats of the udder to be able to milk the animal.

A drawback of this known art from EP-A-0.432.148 lies in the nature of the livestock, in particular cows. When the length of such an apparatus known as a milking box is adjusted while the animal is situated in the milking box, the majority of the livestock reacts nervously when they notice the feed trough is coming towards the animal. The animal is forced backwards, without being aware of where to, which inspires panic. The above identified European patent application further refers to adjustment in advance, before an animal for milking enters the milking box. This however requires memory capacity as well as detection means in order to determine which specific animal is entering the apparatus. The animal in question must then wait because detection takes place in the vicinity of the milking box, and the milking box can be adjusted to the relevant length only after detection or identification of the specific animal.

The present invention has for its object to obviate or at least alleviate the above stated drawbacks of the known art, for which purpose an apparatus according to the present invention is distinguished in that the placing means comprise a frame part on the rear side of the frame, which frame part is movable away from and toward the front side of the frame, and the milking robot is adapted to orient itself to the udders in relation to the frame part.

An apparatus according to the present invention causes less stress in the livestock for milking and can have a quite simple configuration which is no more complex than the known one, since a frame part of the frame still has to be displaced to adapt the milking box to the length of a relevant animal, although this takes place from the rear. The animal is urged forward and, once an animal is properly enclosed, the milking robot can be activated and can orient itself in relation to the frame part displaceable on the rear side. The search area for the milking robot remains small and complex identification or recognition means in combination with memory capacity can de dispensed with.

In a first potential preferred embodiment the milking box is fixed on the frame part and movable therewith. This is useful and advantageous in enabling the milking robot to orient itself in relation to the frame part, since the milking robot is fixed thereon.

In an alternative embodiment the robot is movable separately of the frame part. In such an embodiment the control of the milking robot will have to be supplied with some information about the actual position of the movable frame part. This can be achieved for instance with detectors. In such an embodiment it can be favourable when a teat cup holder separate from the milking robot is movable with the frame part. The teat cup holder must in any case remain stationary in the vicinity of the apparatus, but the milking robot can displace to another configuration of frame etc., to there take teat cups out of the teat cup holder present at that position and arrange them on the udder. Because the teat cup holder is stationary relative to the movable frame part it can also be used as point of orientation for the milking robot.

In yet another embodiment the milking robot can be stationary and comprise detection means for detection of the frame part. The milking robot can further have a reach corresponding with a range of movement of the frame part to enable it to orient itself on udders of the livestock for milking in relation to the frame part in any movement position hereof.

In a particularly favourable embodiment the frame part which is anyway movable can be used to drive out milked livestock, i.e. after milking has been completed. In particular according to the present invention such a driving-out position of the frame part, which is movable on the rear side of the milking apparatus, is favourable because when the frame part has such a dual function the animal in question can leave the milking apparatus while walking forward.

The different characteristics, advantages and special features of apparatuses according to the present invention will become apparent in the light of the following description formulated with reference to the annexed figures, in which the same or similar parts and components are designated with the same reference numerals, and in which:

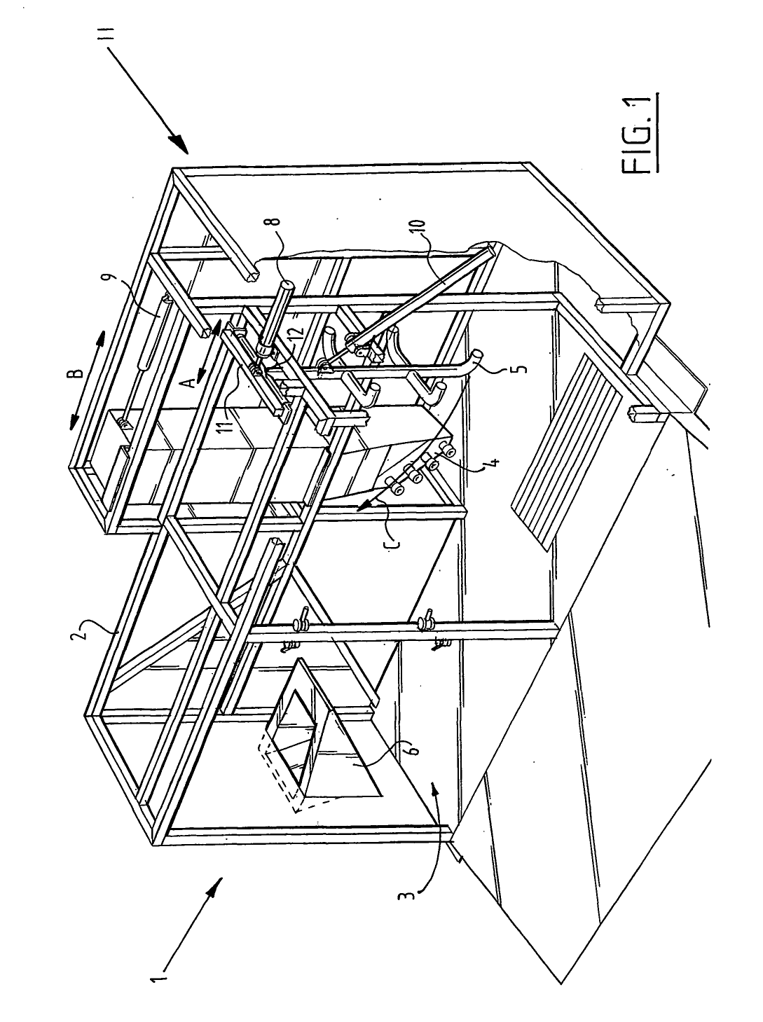

FIG. 1 shows a partly cut-away perspective view of an apparatus for milking livestock according to the present invention;

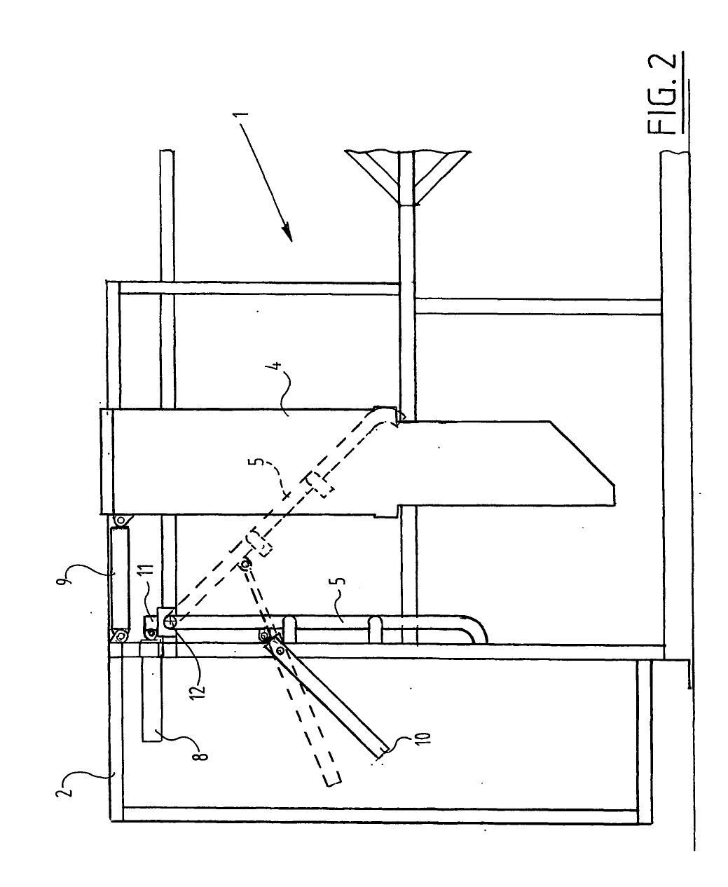

FIG. 2 is a schematic side view of the apparatus shown in FIG. 1 in a first situation;

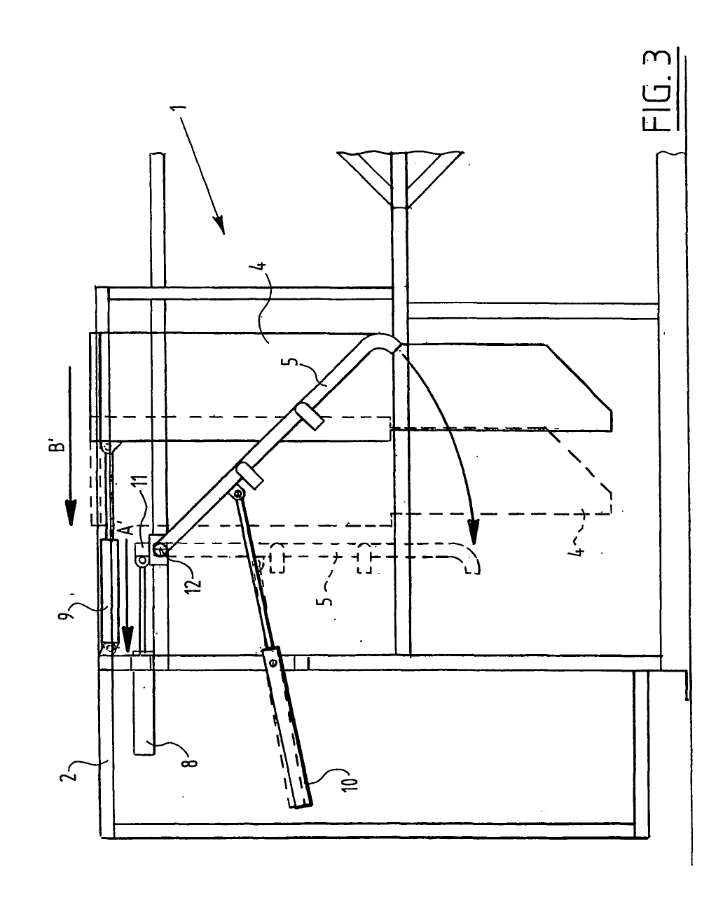

FIG. 3 is a view corresponding with FIG. 2 in a second situation; and

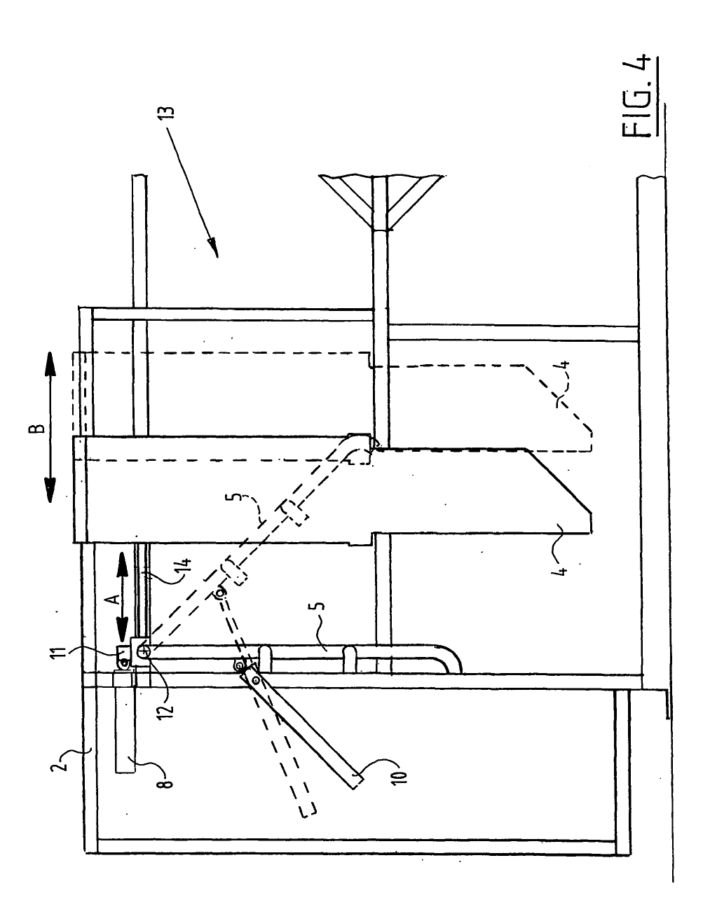

FIG. 4 is a schematic side view of an alternative embodiment of a milking apparatus according to the present invention.

FIG. 1 shows a partly cut-away perspective view of a milking apparatus according to the present invention known as a milking box 1.

Milking box 1 comprises a block-shaped frame 2 with an open side 3 in which a movable entrance and/or exit gate can be arranged. Such entrance and/or exit gates are not shown in FIG. 1 for the sake of clarity.

Arranged on the front side of the milking box 1 relative to heads of livestock for milking is a feed trough 6 from which the livestock for milking can eat during the milking. Further arranged in milking box 1 are teat cups 7 which in the view of FIG. 1 are received in a teat cup holder 4. At the rear of milking box 1 a movable frame part designed as a rear fence 5 is arranged movably in the frame. The positions of rear fence 5 in milking box 1 will be elucidated with reference to FIGS. 2 and 3.

When rear fence 5 is displaced in upright position in the direction of double arrow A under the influence of cylinder 8, this causes a displacement of teat cup holder 4 in the direction of double arrow B under the influence of a cylinder 9. Teat cup holder 4 is preferably substantially stationary relative to rear fence 5, i.e. a movement in forward direction or rearward direction of rear fence 5 involves the same movement of teat cup holder 4 over the same distance. In such a configuration the position of teat cup holder 4 relative to rear fence 5 is always the same, so that a milking robot (not shown), which according to the present invention orients itself in relation to rear fence 5, can find teat cups 7 in teat cup holder 4 at all times. The invention is of course not limited hereto. The teat cup holder can be stationary in the position thereof shown in FIG. 1 and not be displaceable in the direction of arrow B. A control of the milking robot (not shown) can find teat cup holder 4 in relation to rear fence 5 using only some knowledge of a starting position of rear fence 5 in combination with the momentary position of rear fence 5. Teat cup holder 4 can also move through distances different from rear fence 5. The control of the milking robot (not shown) can then still always find teat cups 7 with some prior knowledge of both momentary positions.

Rear fence 5 is displaceable in the direction of double arrow A to enclose an animal for milking prior to the actual milking of the animal with teat cups 7. An animal for milking is pushed forward in the direction of feed trough 6 by displacing the rear fence forward. When the animal is then enclosed in the desired manner between feed trough 6 and rear fence 5, the milking robot (not shown) can orient itself according to the present invention in relation to the rear fence 5 as embodiment of the movable frame part in order to find teat cup 7 in teat cup holder 4, and to localize the teats on an udder of an animal for milking in a very limited search area and to connect the teat cups 7 thereto.

It is noted that a rearmost extreme position of rear fence 5 is shown in full lines in FIG. 2, while FIG. 3 shows in broken lines the other foremost extreme position of rear fence 5 for moving or displacing of rear fence 5 to enclose an animal for milking. The thus illustrated range of movement of rear fence 5 corresponds with the diversity of lengths of livestock animals for milking in longitudinal direction of milking box 1. Such a range between said extreme positions in the movement of rear fence 5 in the direction of arrow A can amount for instance to 30 or 40 cm, although the invention is limited thereto.

FIG. 1 also shows that under the influence of a cylinder 10 the rear fence 5 can also pass through a swivelling movement in the direction of arrow C. For this purpose the rear fence 5 is suspended from a carriage 11 on which the cylinder 8 engages for displacement in the direction of double arrow A. Carriage 11 is displaceable in sliding, rolling or other manner over the top side of frame 2 and comprises a swivel coupling 12 from which rear fence 5 is suspended.

When cylinder 10 is energized the rear fence swivels forward and upward in the direction of arrow C. In the situation where an exit gate (not shown) in the open side 3 of frame 2 is opened this is favourable for inducing a livestock animal for milking in milking box 1 to leave milking box 1. Some types of livestock, such as cows in particular, tend to want to stay at the feed trough 6 in the expectation that this will provide them with further feed. This is not desirable after completion of the milking process and can reduce the throughput capacity of milking box 1, which is effectively prevented with the driven swivelling of rear fence 5.

Cylinder 10 is suspended on frame 2 such that the swivelling movement of rear fence 5 can be realized irrespective of the position of carriage 11 in the direction of double arrow A. FIGS. 1 and 2 show the situation wherein, when cylinder 10 is energized, rear fence 5 is swivelled forward and upward from a first position of rear fence 5 furthest to the rear to a second position corresponding to driving of the livestock out of the apparatus after completion of the milking, this latter being shown in broken lines. This is therefore a situation where very long animals are milked in the direction of milking box 1 and neither rear fence 5 nor teat cup holder 4 have to be placed displaced in the direction of arrows A and B respectively.

Conversely, FIG. 3 shows the situation where prior to milking of an animal the carriage 11 is displaced forward in the direction of a third position shown in broken lines. Carriage 11 with rear fence 5 in upright position thereon is herein displaced forward to limit the space available to an animal for milking and to enclose the animal. For this purpose the cylinder 8 is energized to displace the carriage in forward direction, i.e. toward the feed trough 6 in FIG. 1. From the third position of rear fence 5 shown in broken lines the rear fence 5 is once again pivotable to the position designated for the sake of convenience as second position, which second position corresponds with driving out milked animals.

It is noted that teat cup holder 4 as already described above has progressed through the same displacement in the same direction and over the same distance as carriage 11 under the influence of cylinder 9. The position of teat cup holder 4 in relation to rear fence 5 in the upright third position thereof shown in broken lines is thus readily known to the control of a milking robot (not shown).

After completion of the milking and once the milked animal has been induced to leave milking box 1, in that under the influence of cylinder 10 the rear fence 5 is swivelled forward and upward to the second position thereof shown in broken lines in FIG. 3, cylinder 10 can be de-energized in order to return rear fence 5 to the third position thereof shown in broken lines in FIG. 3. Simultaneously or subsequently or even prior thereto the carriage 11 and teat cup holder 4 can be returned to the starting position thereof corresponding with the first position of rear fence 5 as is shown in FIG. 2 in full lines. This movement is indicated with the single arrows A′ and B′.

FIG. 4 shows a milking box 13 as embodiment of an apparatus according to the present invention which is an alternative to that of FIG. 1. This embodiment of milking box 13 differs from that of FIGS. 1, 2 and 3 in a rigid connection 14, for instance a rod, between carriage 11 and teat cup holder 4. Only a single cylinder 8 is thus sufficient to bring about the movement of carriage 11 in the direction of double arrow A simultaneously with the movement of teat cup holder 4 in the direction of double arrow B. For the swivelling movement of rear fence 5 a separate drive in the form of cylinder 10 is however still necessary in this milking box 13.

After examination of the foregoing many alternative and additional embodiments will occur to the skilled person. The invention is not however limited to the embodiments explicitly shown in the figures and described above. It is thus undoubtedly possible to bring about the movements between the three positions with a single drive. The teat cup holder can be stationary relative to the frame instead of being stationary relative to the rear fence as embodiment of the movable frame part. It is even possible for the teat cup holder to be moved and displaced over other distances and in other directions than rear fence 5 as long as a control of a milking robot is provided with information about the absolute and/or relative movements of the rear fence and the teat cup holder to enable it to find the teat cups engaged by the teat cup holder in relation to the rear fence and then orient itself, in relation to the rear fence, to the teats on an udder of an animal for milking. Drives can further be used other than hydraulic cylinders as explicitly described in the foregoing. Since the drives can generally be arranged high on the frame, it is even possible to use for instance electric motors which would otherwise not be applicable in an environment little suited to electric motors. The milking robot can be designed in different ways and be positioned at diverse locations. The milking robot can be designed as an industrial robot such as is known from the European patent application 98.202950.6 of the present applicant. The milking robot can further be placed on the side opposite the teat cup holder or on the same side, wherein in the latter case the teat cup holder is preferably rotated a quarter-turn, i.e. with the teat cups directed toward the milking robot. The carriage, from which the rear fence is suspended as movable frame part, can also have different embodiments. The upper side of the frame over which the carriage runs can for instance be provided with gear racks on which free-running or driven toothed wheels, which are arranged rotatably on the carriage, can engage. In a driven embodiment of the toothed wheels a drive for the toothed wheels takes over the task of the cylinder explicitly described in the figures, which is therefore unnecessary. Using suitable aligning means the carriage can also travel on rollers or wheels over the upper surface of the frame, or it is even possible that slide blocks reducing sliding resistance will alone suffice, and so on.

1. Apparatus for milking livestock such as cows, comprising: a block-shaped frame open on one side and having a front side and a rear side relative to respectively head and udder of livestock for milking in the milking box, and having a movable entrance and/or exit gate for selectively opening an entrance and/or exit in the open side of the frame; teat cups for milking the livestock with for instance a milking robot; and placing means for positioning livestock for milking at a desired location with udders thereof at a predefined location,
wherein the placing means comprise a frame part on the rear side of the frame, which frame part is movable away from and toward the front side of the frame, and the milking robot is adapted to orient itself to the udders in relation to the frame part.

2. Apparatus as claimed in claim 1, wherein the milking box is fixed on the frame part and movable therewith.

3. Apparatus as claimed in claim 1, wherein the milking robot is movable separately of the frame part.

4. Apparatus as claimed in claim 3, wherein a teat cup holder separate from the milking robot is movable with the frame part.

5. Apparatus as claimed in claim 1, wherein the milking robot is stationary, comprises detection means for detection of the frame part, and has a reach corresponding with a range of movement of the frame part.

6. Apparatus as claimed in any of the foregoing claims, wherein the frame part is at least movable between a first position which corresponds with a greatest length of livestock for milking and a second position with corresponds with the urging of livestock out of the apparatus after completion of the milking.

7. Apparatus as claimed in claim 6, wherein the frame part is movable in two stages between the first and the second position via a third intermediate position substantially corresponding with a smallest length of livestock for milking.

8. Apparatus as claimed in claim 7, wherein the frame part is movable in upright position between the first and the third positions and is movable in tilting manner between the second and third positions.

9. Apparatus as claimed in claim 7 or 8, wherein the frame part is arranged tiltably on a carriage, and the carriage is connected to a first drive for displacement between the first and the third positions, and the frame part is connected to a second drive for displacement between the second and third positions.
